(19) United States
(12) Patent Application Publication
(10) Pub. No.: US 2016/0138324 A1
(43) Pub. Date: May 19, 2016

(54) VACUUM WINDOWS WITH RETICULATED SPACER

(71) Applicants: Jeffery L. Lameris, Grand Haven, MI (US); Harlan J. Byker, West Olive, MI (US); Christopher D. Anderson, East Grand Rapids, MI (US); Samuel J. DeJong, Allendale, MI (US); Chad Simkins, Rockford, MI (US)

(72) Inventors: Jeffery L. Lameris, Grand Haven, MI (US); Harlan J. Byker, West Olive, MI (US); Christopher D. Anderson, East Grand Rapids, MI (US); Samuel J. DeJong, Allendale, MI (US); Chad Simkins, Rockford, MI (US)

(73) Assignee: Pleotint, L.L.C., West Olive, MI (US)

(21) Appl. No.: 14/943,495

(22) Filed: Nov. 17, 2015

Related U.S. Application Data
(60) Provisional application No. 62/080,768, filed on Nov. 17, 2014.

(51) Int. Cl. E06B 3/66; E06B 3/673; E06B 7/28; E06B 3/663; E06B 3/677

(52) U.S. Cl. CPC E06B 3/6612; E06B 3/66304; E06B 3/6775; E06B 7/28; E06B 3/67326; E06B 2009/2417

(57) ABSTRACT

A vacuum window unit including two spaced apart and substantially parallel sheets of glass, a spacer having a plurality of walls perpendicular to the sheets of glass, the spacer defining a reticulated or a honeycomb or a cellular structure, and a vacuum, a partial vacuum, or a substantially reduced gas pressure as compared to a normal atmospheric pressure between the sheets of glass and within the cells of the spacer. The spacer is positioned between the two sheets of glass to maintain spacing between the two sheets of glass.

### CROSS-REFERENCE TO RELATED APPLICATIONS

The present application claims priority to U.S. Provisional Patent Application No. 62/080,768, filed Nov. 17, 2014, titled VACUUM WINDOWS WITH RETICULATED SPACER, the entirety of which is hereby incorporated by reference herein.

### TECHNICAL FIELD

The present invention relates to multi-pane windows, and more particularly to vacuum windows incorporating spacers between the panes thereof, and methods of constructing the same.

### BACKGROUND

Heat transfer through windows is a major concern for the use of windows in buildings and vehicles. Three means of heat transfer are known: conduction, convection and radiation. Providing a vacuum or reduced gas pressure within multipane window unit or structure substantially decreases heat transfer by conduction and convection. Combing a low emissivity (“low-e”) coating with the vacuum or reduced pressure allow all three means of heat transfer to be addressed.

### SUMMARY

In one aspect, a vacuum window unit is disclosed. The vacuum window unit includes two spaced apart and substantially parallel sheets of glass, a spacer having a plurality of walls perpendicular to the sheets of glass, the spacer defining a reticulated or a honeycomb or a cellular structure, and a vacuum, a partial vacuum, or a substantially reduced gas pressure as compared to a normal atmospheric pressure between the sheets of glass and within the cells of the spacer. The spacer is positioned between the two sheets of glass to maintain spacing between the two sheets of glass.

In another aspect, a vacuum window unit is disclosed. The vacuum window unit includes two spaced apart and substantially parallel sheets of glass defining inner opposed surfaces and a spacer having a plurality of walls perpendicular to the sheets of glass, the spacer defining a reticulated or a honeycomb or a cellular structure. The plurality of walls includes a first face and a second opposite face spaced away from the first face. The first face is transparent or includes a light absorbing or reflecting portion and the second face in transparent or includes a light absorbing or reflecting portion. The window unit includes a vacuum, a partial vacuum, or a substantially reduced gas pressure as compared to a normal atmospheric pressure between the sheets of glass and within the cells of the spacer. The spacer is positioned between the two sheets of glass to maintain spacing between the two sheets of glass. The reticulated or honeycomb or cellular structure of the spacer spans a portion or substantially the entire surface area of the inner opposed surfaces of the two sheets of glass.

In another aspect, a method of installing a vacuum window unit is disclosed. The method includes providing a vacuum window unit, the unit including two spaced apart and substantially parallel sheets of glass and a spacer having a plurality of walls perpendicular to the sheets of glass, the spacer defining a reticulated or a honeycomb or a cellular structure. The plurality of walls includes a first face and a second opposite face spaced away from the first face. The first face is transparent or includes a light reflecting or absorbing portion and the second face is transparent or includes a light absorbing or reflecting portion. The window unit includes a vacuum, a partial vacuum, or a substantially reduced gas pressure as compared to a normal atmospheric pressure between the sheets of glass and within the cells of the spacer. The spacer is positioned between the two sheets of glass to maintain spacing between the two sheets of glass. The method further includes installing the vacuum window unit into a wall of a structure with a floor and a ceiling, where the vacuum window unit is oriented with the first face of the plurality of walls of the spacer positioned more proximate to the ceiling and the second face of the plurality of walls of the spacer positioned more proximate to the floor to redirect incident light toward the ceiling.

Other aspects of the invention will be apparent to those skilled in the art based on the discussion and disclosures herein.

### BRIEF DESCRIPTION OF THE DRAWINGS

FIG. 1 shows three embodiments of patterns for reticulated spacers in accordance with the disclosed vacuum window. FIG. 1a depicts a honeycomb embodiment, FIG. 1b depicts an embodiment with localized arrays of circles, and FIG. 1c depicts an embodiment of localized strips.

FIG. 2 shows a side view of a vacuum window incorporating a reticulated spacer in accordance with the embodiments of FIG. 1.

FIG. 3 is a detailed view of a portion of the side view of the vacuum window of FIG. 2.

FIG. 4 shows a schematic of an embodiment of a window incorporating a coated reticulated spacer in accordance with one embodiment. FIG. 4A depicts the impact of a light reflecting portion, FIG. 4B depicts the impact of a light absorbing portion, and FIG. 4C depicts an embodiment of a reticulated spacer with light reflecting and light absorbing portions.

### DETAILED DESCRIPTION

The invention involves a window unit with two spaced apart and substantially parallel sheets of glass where the spacing is maintained by a spacer that has a reticulated or honeycomb or other cellular structure or shape. In one embodiment, the spacer serves to keep the glass sheets relatively flat and parallel. This spacer is also effective in keeping the sheets of glass from coming into contact with each other when the interior space between the sheets of glass and within the cell structure of the reticulated spacer has a vacuum or partial vacuum or a substantially reduced gas pressure, and the exterior of the window unit is exposed to normal atmospheric pressure. In some embodiments, the spacer is adhered to the glass along the thin or fine edges of the spacer, (edges of the cell walls), while the assembly is under partial vacuum and at least temporarily maintains the reduced pressure or vacuum between the sheets of glass until one or more than one perimeter seal is applied to the window unit. The perimeter seal is constructed in a manner that provides a barrier that substantially reduces the diffusion of gasses into the window unit and provides the flexibility required to allow for the thermal expansion and contraction of the glass sheets. A somewhat flexible perimeter seal is particularly important in embodiments where the window unit is installed in a building or vehicle, and the temperature of the outside pane deviates substantially from the temperature of the inside pane. The reticulated spacer, with its cellular structure, is effective at maintaining the spacing while at the same time allowing a significant amount of light to pass through the window, and the spacer often even allows substantially unobstructed images to be viewed through the window. This means that in some embodiments, there is little or no diffuse light or scattering of the light passing through the window units, while in other embodiments, scattering or diffusion of light is specifically provided for by other means.

One method of preparing vacuum window units with reticulated spacers is to provide an adhesive material on the glass or on the reticulated spacer, such as a thermoplastic or a thermoset adhesive material. The spacer is placed between two sheets of glass in a vacuum chamber or vacuum bag. The chamber may be flexible or rigid. If the chamber is rigid the chamber may employ a platen inside the chamber to press out the unit after the chamber is evacuated. Generally a vacuum is pulled and then the temperature of the assembly is raised under vacuum. For a thermoplastic adhesive material, the temperature is raised to the point where the thermoplastic softens and forms a bond between the spacer and the glass while the vacuum is maintained on the assembly. The temperature of the assembly is then lowered to the point where the thermoplastic adhesive material becomes rigid and forms a seal, and then the vacuum is released. For a thermoset adhesive, the temperature is raised to the point that the thermoset cures within a relatively short period of time and forms a bond between the spacer and the glass sheets, while the vacuum is maintained on the assembly. Once a rigid bond and seal is formed and the temperature of the assembly is lowered, the vacuum is then released.

Another method of forming a vacuum window involves bonding a low gas permeability “edge seal spacer” around or near the perimeter of one sheet of glass with a low gas permeable sealant or adhesive, and then laying a reticulated or honeycomb spacer on the glass sheet inside the area formed by the edge seal spacer. The reticulated spacer covers at least some or nearly all of the area of the glass sheet. This assembly optionally includes one or more than one bonding agent to bond the spacer directly to the glass sheets. This assembly is placed in a vacuum chamber, and a second glass sheet is bonded to the edge seal spacer after the vacuum is formed within the spacer containing assembly. The second glass sheet is bonded to the edge seal spacer with a low gas permeability sealant or adhesive generally with the application of heat and/or pressure. The assembly is then removed from vacuum and an optional secondary seal may be applied.

Another method of forming a vacuum window involves an edge seal spacer bonded around the perimeter of both sheets of glass, where a reticulated spacer has been placed in the view area of the window. After the unit is bonded together, a vacuum is pulled through a port in the glass or the edge spacer, followed by plugging or sealing the port. Optionally, after the vacuum is provided, the reticulated spacer is also bonded and sealed to each glass sheet.

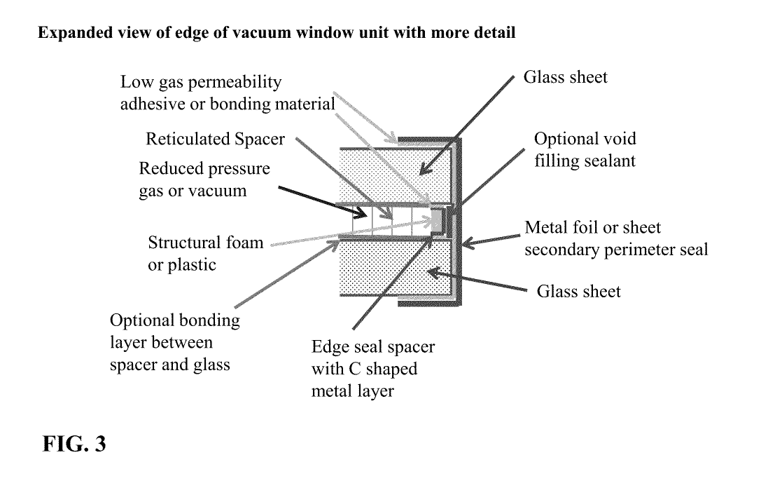

Once a vacuum is provided within the window unit, an optional secondary perimeter sealing system may be applied. Optionally, an initial sealant is applied to fill void spaces, if any, between the reticulated spacer and/or the edge seal spacer and the edges of the glass sheets. If this sealant is necessary, it generally provides a seal that is flush with the edges of the glass sheets around the perimeter of the window unit. This is shown in FIG. 3 as the “optional void filling sealant.” Then, a metal secondary seal foil or sheet is bonded in a picture frame fashion to the edges of the unit, and, in one embodiment, also to the outside surfaces of the window unit. This secondary or additional seal system provides improved retention of the vacuum that is within the window unit because the metal foil or sheet provides a barrier that is completely impermeable to gasses. A low gas permeability adhesion layer is used to form a bond between the metal barrier and the glass sheets.

The metal barrier layer may preferably be flexible. A major challenge in the vacuum window industry is how to manage the thermal expansion and contraction of the glass sheets. At some times, the glass sheets are at nearly the same temperature, and at other times, the external sheet may experience a significantly different temperature than the interior sheet. This thermal expansion/contraction induces a change in the sizes of the glass sheets during temperature changes, which, in turn, causes significant stress and breakage of the rigid seals and barriers often used in attempts to make commercially viable vacuum window units. The present invention readily accommodates stresses due to temperature gradients by using flexible and often thin metal foils or sheets as at least part of the barrier to prevent gasses from permeating into the window and compromising the vacuum.

Getters

The reduced pressure in the sealed unit may be maintained or improved by the use of getter materials in the vacuum space. The getters may absorb or react with oxygen, nitrogen, carbon dioxide and/or volatile organic compounds to form solids and thereby remove gas phase materials from the gas phase.

Reticulated Spacer

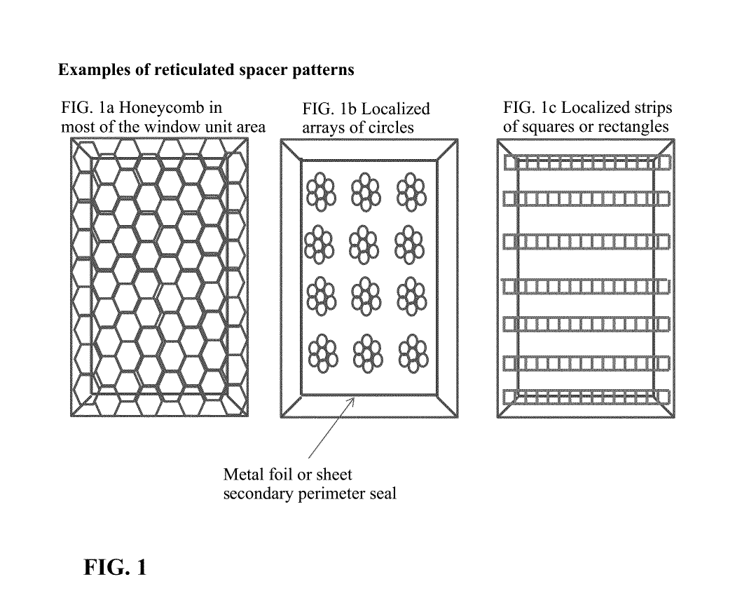

Referring now to FIG. 1, the reticulated spacer is made up a plurality of cells which contain gas or vacuum, and cell walls which are a solid, and in one embodiment, transparent, material. The cell walls may be oriented parallel with the plane of the sheets of glass, but preferably they are oriented perpendicular to the plane of the sheets of glass. In one embodiment, the reticulated spacer is made from a plastic, such as acrylic or light stabilized polycarbonate. The spacer may alternately be made from other plastic, polymer, copolymer, carbon, glass, metal or metal coated plastic, or a combination thereof, that is rigid and that has the structural integrity when in the form of a reticulated spacer to maintain the spacing between the glass sheets under conditions when there is at least approximately 100,000 pascals of atmospheric pressure on the outside of the window unit and less than approximately 10,000 pascals of gas pressure on the inside of the window unit. Other materials from which the reticulated spacer may be made include polyvinylchloride, ethylenevinylacetate, polyethylene-co-methacrylic acid which may contain metal ions like lithium, sodium or zinc, polyethyleneterephthalate, poly(vinylbutyral-co-vinylalcohol-co-vinylacetate), cyclic olefin polymers and copolymers and metals such as aluminum, steel including stainless steel, and INCONEL®.

The spacer thickness of the reticulated spacer, and thus the approximate spacing between the glass sheets, is about 0.0003 to 0.3 meter thick and, more particularly, about 0.003 meter to 0.03 meter thick. The cell walls may be about 0.00001 to about 0.001 meter and, more particularly, about 0.00005 to 0.0005 meter, and the cell width/diameter may be about 0.001 to 0.05 meter and, more particularly, about 0.003 to about 0.03 meter in width or diameter. When the cell walls of the reticulated spacer are oriented perpendicular to the plane of the glass sheets, the ratio of total open areas of the cells to the total area of the cell walls is, in one embodiment, greater than or equal to 10, and in another embodiment greater than or equal to 20. A high ratio here has at least two advantages. First, a larger proportion of total window area is unobstructed viewing area. Second, the larger ratios are obtained with thinner cell walls, and thinner cell walls are better with regard to heat transfer via conduction from one sheet of glass to the other through the cell wall material. One method of making reticulated spacers is to extrude thin-walled geometric tubes such as circular, oval, trapezoidal, square, rectangular, or hexagonal tubes of plastic or metal. Other shapes may also be suitable. The extruded polymer may contain one or more than one type of getter. These tubes are stacked and glued or bonded together along what will become the cell walls. Generally, the tubes will be in a relatively close-packed configuration or packed in a manner that the walls will form additional cells in the stacking process. The tubes are then cut or sawn-through in a direction transverse to the long orientation of the tubes to form reticulated or honeycomb or cellular sheets.

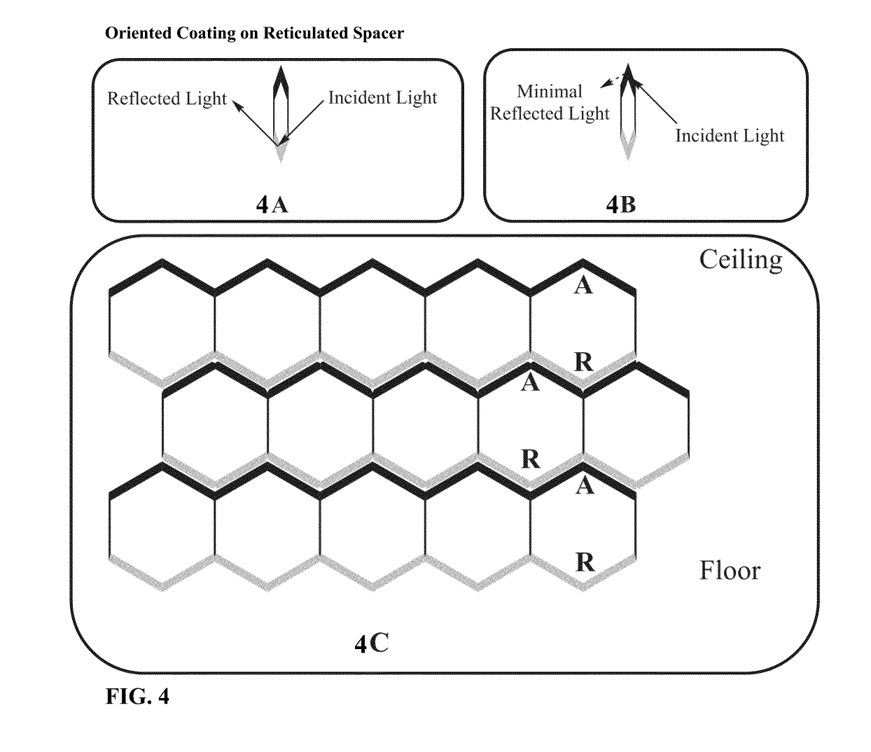

The reticulated spacer may include special structures or reflective or metalized areas effective to direct incoming light deep into the interior space of a building or vehicle. In one embodiment, the spacer material is coated with a reflective material, for example silver metal or chromium metal, or other reflective materials, which redirect incident light as shown in FIG. 4A. Of particular interest is the redirection of incident light toward the ceiling or deeper into the space of an occupied space to improve the amount of daylighting. The reticulated spacer may have an orientation where part of the bottom of the walls of some cells is reflective and/or part of the top of the walls of some cells is transparent or absorbing to light. In this embodiment, the reticulated spacer is partially or differentially coated to selectively redirect incident light. In FIG. 4C, a reticulated spacer is shown with a reflective coating, labeled “R,” on the lower portion of inside face of the spacer. Also shown in FIG. 4C is an optional light absorbing portion of the spacer, labeled “A.” The reflective coating shown in FIG. 4C is capable of selectively reflecting incident light toward the ceiling of the occupied space. When the partially light reflecting reticulated spacer has an optional light absorbing portion, the redirection of incident light directly onto work surfaces is minimized. FIG. 4B illustrates the light absorbance of this spacer option. In practice, the absorbing portion of the spacer can comprise an absorbing component or it can be coated with an absorbing layer including, for example, pigments and/or dyes. This light redirecting embodiment is effective with or without reduced pressure in the insulated glass unit.

The reticulated spacer may be arranged in any of a variety of configurations between the window panes. The reticulated spacer may cover most or essentially all of the area of the window unit, for example as shown in FIG. 1a, or the reticulated spacer may cover only a portion of the window unit area as shown in FIGS. 1b and 1c. The reticulated spacers may be arranged in the form of an array of discs, strips, squares, or any of a variety of other geometric patterns or shapes, and/or the reticulated spacers may be arranged in decorative patterns, including but not limited to the shape of birds, flowers or leaves. A preferred shape of the reticulated spacer is a bird of prey that frightens other birds away and helps prevent bird strikes.

Optional Edge Seal Spacer

The optional edge seal spacer may be made from any plastic, glass, ceramic, or metal or combinations thereof which is strong enough not to be crushed or sucked into the assembly once it experiences atmospheric pressure on the outside. It may be flexible enough not to break or exert undue stress on the seals or sealants that bond it to the glass during actual use of the window, when there may be large temperature differentials between the glass sheets.

One embodiment of an edge seal spacer is a thermoplastic that forms a bond directly to glass, such as a material commonly used in making safety glass interlayers. These materials include poly(vinylbutyral-co-vinylalcohol-co-vinylacetate) (PVB), thermoplastic polyurethane (TPU), poly(ethylene-co-vinylacetate) (EVA), and/or ionomers such as polyethylene-co-methacrylic acid, with or without metal ions such as sodium, lithium or zinc.

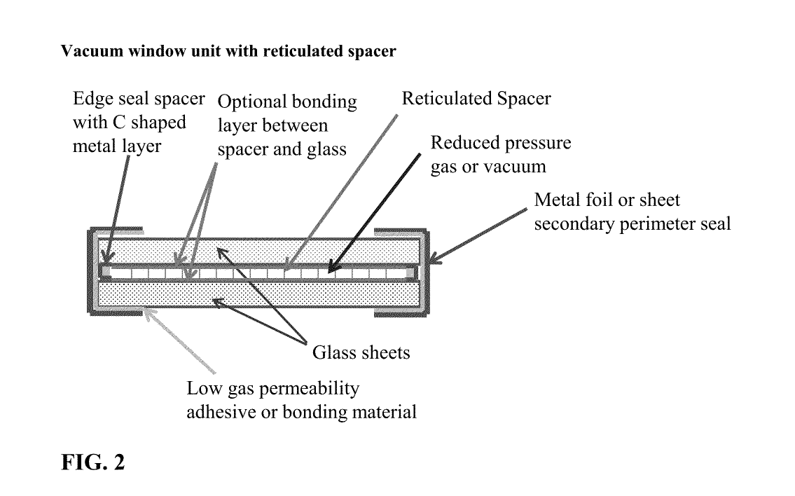

Another embodiment of an edge seal spacer is shown in FIGS. 1 and 2 as a generally C-shaped metal channel with an optional flexible plastic or foam material contained in the channel. The flexible plastic or foam material may be made an open or closed cell foam made, for example, from polyvinylchloride or polyurethane. Metal for the generally C-shaped channel is preferred because of its formability, flexibility when thin, and essential zero permeability for gasses and may be structurally reinforced along the open end of the “C” with metal or plastic strips. In one embodiment, the metal is aluminum or an alloy of aluminum. In another embodiment the metal is stainless steel. The metal in the generally C-shaped channel is, in one embodiment, at least about 1×10⁻⁶ meters thick, in which case it may essentially be a metal layer coated on the plastic or foam within the generally C-shaped channel. The metal that make up the spacer shape may be thinner than about 1×10⁻³ meters thick to help minimize heat conduction through the edge seal spacer. With the proper choice of an edge seal spacer, it may not be necessary for the reticulated spacer be bonded to the glass sheets—rather, the reticulated spacer may simply be contained between the glass sheets. This has the added advantage that no adhesive will be present in the view through the window unit which might otherwise distort or obscure part of the view. On the other hand, a bond between the reticulated spacer and the glass may still be desirable to impede gas diffusion throughout the window unit and help prevent scattering of glass should the window unit be broken.

The adhesive or bonding agents that bond the edge seal spacers to the glass are preferably thermoplastics or rubbers like butyl rubber or polyisobutylene. However a thermoset type material such as an epoxy or urethane may also be used. Also it is possible to use a glass to metal seal of the type known in the art of glass to metal seals. If metal is used in the edge seal spacer it may be made into a continuous seal by welding, soldering or sealing with adhesives. This may be at the corners which may be mitered or connected with corner keys. Alternately, a continuous plastic edge seal spacer may be provided and may optionally be coated or wrapped with metal by various methods know in the art for coating metals on plastic.

A properly-designed edge seal spacer may maintain reduced pressure or at least partial vacuum within the window unit for a number of years. However, in some case it may is preferable to provide a secondary edge seal.

Optional Secondary Edge Seal

In one embodiment, the reticulated spacer is bonded to the glass sheets, and this bond seals the vacuum within the cells of the reticulated spacer and throughout the window unit long enough for the unit to be removed from vacuum and then provided with a secondary edge seal. This is advantageous since a secondary seal may be difficult to provide in the vacuum chamber. In another embodiment, an optional secondary edge seal may also be used to help extend the life of the vacuum in the window units, even when the reticulated spacer is not bonded to the glass sheets and an edge seal spacer is present.

One embodiment of a secondary edge seal is shown in FIGS. 1-3. The secondary edge seal includes a metal foil or sheet and a low gas permeability adhesive or bonding material. In one embodiment, the metal is aluminum or an alloy of aluminum. In another embodiment the metal is stainless steel. The metal provides essentially zero permeability for gasses and the low gas permeability adhesive or bonding material can provide a barrier for many years when the edge seals are properly designed.

The permeation through the low gas permeability layer or adhesion layer is made very low by:
1. Choosing an adhesive or bonding material with low permeability for gasses;
2. Making the area through which gasses can permeate very small; and/or
3. Making the length of the path through which the gasses must permeate as long as is practical.

This generally means that the thickness of the adhesive layer between the metal barrier and the glass sheets is very thin, and in one embodiment, between about 5×10⁻⁸ meters and about 1×10⁻⁴ meters thick. The length of the adhesive layer is as long as practical and, in one embodiment, between about 1×10⁻³ meters and about 0.2 meters long. The adhesive or bonding material may include, for example, epoxy-based adhesives with various curing agents or homopolymerized epoxy bisphenol A digycidyl ether-based resins. Alternately, the adhesion layer may be provided by urethanes, silicones, silane modified polymers, polyvinylidene fluoride, polyvinylidene chloride, polyvinylalcohol, poly(ethylene-co-vinylalcohol), low or no plasticizer containing poly(vinylbutyral-co-vinylalcohol-co-vinylacetate) and combinations thereof. Alternately the bonding may involve glass to metal seals know in the art of glass to metal bonding. Preferred are thermoset adhesives, and especially preferred are those based on epoxy resins, with various catalysts, curing agents or curing methods.

Vacuum or Reduced Pressure

The vacuum or reduced pressure in the window unit is, in one embodiment, between about 1×10⁻⁴ and about 10,000 pascals. For very low pressures, getters, absorbers and/or adsorbers for various gasses may be provided in the unit to remove traces of gas after final sealing. Even at the higher pressures within the above-disclosed range, the reticulated spacer minimizes convection, and the typically large spacing between the glass sheets with a reticulated spacer as compared to other vacuum window unit spacers helps minimize conduction of the heat even with a small amount of gas present. The vacuum may be formed in a vacuum chamber, a vacuum bag as the unit is being made, or after the window unit is formed, it may be pulled on the window unit through a port in the glass or the spacer system. In any case, one method is to pull an initial vacuum, backfill with a high diffusion rate gas like helium and then pull the final vacuum. This procedure serves to allow low pressures to be achieved in shorter periods of time.

Glass Sheets

The glass sheets are, in one embodiment, soda lime glass formed in a floatline process or a drawn sheet process. Alternately, the glass sheets may be borosilicate or alkali-aluminosilicate glass or boro-alumino-silicate. These glass sheets may be clear, low iron ultra-clear, tinted or selectively absorbing glasses.

One or both of the glass sheets in the vacuum window may be coated with a low-e coating. A particularly advantageous configuration involves a soft coat low-e coating on one of the glass surfaces in contact with the vacuum, with that glass sheet being in contact with the outside of a building or vehicle, and a hard coat low-e on the exterior surface of the other glass sheet. Thus, the exterior surface of the window unit with the hard coat low-e is preferably oriented toward the interior of the building or vehicle into which the vacuum window is installed.

Either glass sheet or both of the glass sheets that help contain the vacuum may be laminated to another glass sheet with an interlayer material like PVB, TPU, EVA, or ionomer like polyethylene-co-methacrylic acid, with or without metal ions such as sodium, lithium or zinc. The interlayer may contain selective ultraviolet, visible and/or near infrared absorbers. One configuration involves laminating one of the glass sheets to another glass sheet with a thermochromic interlayer such as the interlayer known as SUNTUITIVE® supplied by Pleotint, LLC of Jenison, Mich. Either or both of the glass sheets may be strengthened by heat strengthening, tempering, and/or by chemically strengthening and/or toughening. The vacuum window units may be combined in windows with any type of thermochromic, electrochromic, photochromic, polymer dispersed liquid crystals, suspended particle devices, electro-optic, thermotropic or electrotropic materials including those based on the liquid crystals.

Window Configurations

The vacuum window unit or vacuum insulated glazing unit may be used as a standalone window glass unit or it may be used as part of a triple pane window unit where the vacuum insulated glazing unit is on the exterior or interior of a building or vehicle. In this case, a gas space is formed by traditional insulated glass unit means with a gas space between the third glass sheet and the vacuum insulated glazing unit. The vacuum insulated glazing may be part of a quadruple pane window unit where there are two additional glass sheets and two gas spaces and the vacuum insulated glazing unit is preferably between the two additional glass sheets. The gas space may be filled with any type of gas and the additional glass sheets may be any type of glass, including tinted glass, and may be coated with any type of coating, including low-e coatings.

Diffuse Light Transmission

In some cases it may be preferable for the light that is transmitted by the vacuum window units to be diffuse. This may be especially of interest for clearstory windows or places where there is an interest in directing or redirecting light throughout a building or vehicle. Light diffusion may be provided by a number of means in the window unit of the present invention, including using frosted glass or sandblasted glass, laminating one or both of the glass sheets in the vacuum window unit with a light diffusing interlayer, providing light scattering in the reticulated spacer, adhering the reticulated spacer to the glass with a light diffusing adhesive, filling the cells or spaces of the reticulated spacer with light diffusing particles like aerogel particles prior to pulling the vacuum, or combinations thereof.

### Example 1

Two 0.3 meter wide by 0.3 meter long sheets of glass that were each 0.003 meter thick had 100 micron thick films of non-plasticized polyvinylbutyral uniformly bonded on one surface of each sheet of glass in a heated vacuum bag procedure. A 0.3 meter inch by 0.3 meter reticulated spacer made up of circular cells of polycarbonate with approximately 0.006 meter diameter cells and approximately 0.0001 meter thick cell walls was placed between the polyvinylbutyral layers on the sheets of the glass, and the assembly was placed in a flexible silicone vacuum bag. The vacuum bag was evacuated and then heated to the point where the polyvinylbutyral formed a bond to the polycarbonate of the reticulated spacer in such a manner that a vacuum was retained within the cells after the assembly was removed from the vacuum bag. A secondary edge seal was formed around the perimeter of the assembly by bonding aluminum foil that was approximately 2.4×10⁻⁵ meters thick in a frame-like manner, as shown for the “metal foil or sheet secondary perimeter seal” in FIGS. 2 and 3. The aluminum foil was bonded to the glass with a silane coupling agent containing polyamide cured epoxy seal, which was compressed and at least partially cured in a platen press. The resulting epoxy seal was measured to be approximately 4×10⁻⁶ meters thick, and the path length for diffusion of gases down the epoxy bond length was approximately 0.015 meters.

### Example 2

Four TECHNOFORM® spacer strips about 0.3 meter long and about 0.0064 meter thick made from stainless steel and available from Technoform Glass Insulation Holding of Kassel, German were miter cut and joined together at the corners with plastic corner keys. This edge seal spacer frame was bonded to a sheet of glass about 0.3×0.3 meters in size with pre-extruded polyisobutylene primary seal tape available from C. R. Laurence Co., Inc. The polyisobutylene tape was pressed out to form a thin continuous seal. Another layer of pre-extruded polyisobutylene primary seal tape was provided on top of the edge seal spacer. A layer of reticulated spacer about 0.28 meter by 0.28 meter made up of circular cells of polycarbonate with approximately 0.006 meter diameter cells and approximately 0.0001 meter thick cell walls was placed on the glass sheet inside the edge seal spacer. A second sheet of glass about 0.3×0.3 meters in size was suspended about the polyisobutylene primary seal tape on the edge seal spacer in a vacuum chamber equipped with a heater and a platen. The chamber was evacuated to a pressure of about 0.02 pascals, the temperature of the window unit was raised to 50 degrees Celsius and a 0.4 meter by 0.4 meter platen pressed the top sheet of glass onto the polyisobutylene on the edge seal spacer with a pressure of about 3.5×10⁶ Newtons/square meter. The window unit was removed from the vacuum chamber and the unit was provided with a secondary edge seal as described in Example 1.

Although the invention is shown and described with respect to certain embodiments, it is obvious that modifications will occur to those skilled in the art upon reading and understanding the specification, and the present invention includes all such modifications.

What is claimed is:

1. A vacuum window unit comprising:
two spaced apart and substantially parallel sheets of glass;
a spacer having a plurality of walls perpendicular to the sheets of glass, the spacer defining a reticulated or a honeycomb or a cellular structure; and
a vacuum, a partial vacuum, or a substantially reduced gas pressure as compared to a normal atmospheric pressure between the sheets of glass and within the cells of the spacer;
wherein the spacer is positioned between the two sheets of glass to maintain spacing between the two sheets of glass.

2. The vacuum window unit according to claim 1, wherein the spacer retains the glass sheets relatively flat and parallel relative to each other.

3. The vacuum window unit according to claim 1, wherein the vacuum window unit comprises a secondary perimeter seal.

4. The vacuum window unit according to claim 3, wherein the vacuum window unit comprises an edge seal spacer.

5. The vacuum window unit according to claim 1, wherein the vacuum window unit comprises an edge seal spacer.

6. The vacuum window unit according to claim 1, wherein at least one of the plurality of walls of the spacer has a face that is transparent or includes a light absorbing portion.

7. The vacuum window unit according to claim 1, wherein at least one of the plurality of walls of the spacer has a face including a light reflecting portion.

8. The vacuum window unit according to claim 7, wherein the light reflecting portion is a reflective coating.

9. The vacuum window unit according to claim 1, wherein the plurality of walls of the spacer includes a first face and a second opposite face spaced away from the first face, and wherein the first face is transparent or includes a light absorbing portion and the second face includes a light reflecting portion.

10. The vacuum window unit according to claim 9, wherein the first face is parallel to the second face.

11. The vacuum window unit according to claim 1, wherein the spacer is bonded to at least one of the two sheets of glass

12. The vacuum window unit according to claim 1, wherein the spacer is not bonded to either of the two sheets of glass.

13. The vacuum window unit according to claim 1, wherein the two sheets of glass define inner opposed surfaces, and wherein the reticulated or honeycomb or cellular structure of the spacer spans substantially the entire surface area of the inner opposed surfaces of the two sheets of glass.

14. The vacuum window unit according to claim 12, wherein a ratio of total open areas of the cells to the total area of the walls is, in one embodiment, greater than or equal to 10.

15. The vacuum window unit according to claim 1, wherein the walls of the spacer have a thickness of about 0.0003 to 0.3 meter.

16. The vacuum window unit according to claim 1, wherein a unit of the reticulated or honeycomb or cellular structure has a width or diameter of about 0.001 to 0.05 meter.

17. A vacuum window unit comprising:
two spaced apart and substantially parallel sheets of glass defining inner opposed surfaces;
a spacer having a plurality of walls perpendicular to the sheets of glass, the spacer defining a reticulated or a honeycomb or a cellular structure, wherein the plurality of walls includes a first face and a second opposite face spaced away from the first face, and wherein the first face is transparent or includes a light absorbing portion and the second face includes a light reflecting portion; and
a vacuum, a partial vacuum, or a substantially reduced gas pressure as compared to a normal atmospheric pressure between the sheets of glass and within the cells of the spacer;
wherein the spacer is positioned between the two sheets of glass to maintain spacing between the two sheets of glass; and
wherein the reticulated or honeycomb or cellular structure of the spacer spans substantially the entire surface area of the inner opposed surfaces of the two sheets of glass.

18. The vacuum window unit according to claim 17, wherein the walls of the spacer have a thickness of about 0.0003 to 0.3 meter.

19. The vacuum window unit according to claim 17, wherein a unit of the reticulated or honeycomb or cellular structure has a width or diameter of about 0.001 to 0.05 meter.

20. A method of installing a vacuum window unit, the method comprising:
providing a vacuum window unit comprising:
two spaced apart and substantially parallel sheets of glass;
a spacer having a plurality of walls perpendicular to the sheets of glass, the spacer defining a reticulated or a honeycomb or a cellular structure, wherein the plurality of walls includes a first face and a second opposite face spaced away from the first face, and wherein the first face is transparent or includes a light absorbing portion and the second face includes a light reflecting portion; and
a vacuum, a partial vacuum, or a substantially reduced gas pressure as compared to a normal atmospheric pressure between the sheets of glass and within the cells of the spacer;
wherein the spacer is positioned between the two sheets of glass to maintain spacing between the two sheets of glass; and
installing the vacuum window unit into a wall of a structure with a floor and a ceiling, wherein the vacuum window unit is oriented with the first face of the plurality of walls of the spacer positioned more proximate to the ceiling and the second face of the plurality of walls of the spacer positioned more proximate to the floor to redirect incident light toward the ceiling.
